(19) United States
(12) Patent Application Publication
(10) Pub. No.: US 2006/0193203 A1
(43) Pub. Date: Aug. 31, 2006

(54) Apparatus for attenuating noise in marine seismic streamers

(76) Inventors: Stig Rune Lennart Tenghamn, Katy, TX (US); Andre Stenzel, Richmond, TX (US)

Correspondence Address: E. Eugene Thigpen;Petroleum Geo-Services, Inc., P.O. Box 42805, Houston, TX, 77242-2805, US

(21) Appl. No.: 11/059,497

(22) Filed: Feb. 16, 2005

(51) Int. Cl. G01V 1/38

(52) U.S. Cl. 367/20

(57) ABSTRACT

A marine seismic streamer has a hydrophone housing positioned in the streamer with the hydrophone housing having ends and rigid side walls, a hydrophone positioned in the hydrophone housing, a soft compliant solid material filling the housing, and openings in the hydrophone housing adapted to substantially permit passage of pressure waves and to substantially attenuate passage of shear waves. Another embodiment is a hydrophone housing having ends, rigid side walls, and openings in the hydrophone housing adapted to substantially permit passage of pressure waves and to substantially attenuate passage of shear waves. The openings are open ends of the housing, in the side walls of the housing, in the end walls of the housing, or in both the side walls and end walls of the housing.

### CROSS-REFERENCES TO RELATED APPLICATIONS

Not Applicable

### FEDERALLY SPONSORED RESEARCH OR DEVELOPMENT

Not Applicable

### SEQUENCE LISTING, TABLE, OR COMPUTER LISTING

Not Applicable

### BACKGROUND OF THE INVENTION

1. Field of the Invention

This invention relates generally to the field of geophysical prospecting and more particularly to the field of marine seismic surveys. Specifically, the invention is an apparatus for attenuating noise in marine seismic streamers.

2. Description of the Related Art

In the field of geophysical prospecting, knowledge of the subsurface structure of the earth is useful for finding and extracting valuable mineral resources, such as oil and natural gas. A well-known tool of geophysical prospecting is a seismic survey. A seismic survey transmits acoustic waves emitted from appropriate energy sources into the earth and collects the reflected signals using arrays of sensors. Then seismic data processing techniques are applied to the collected data to estimate the subsurface structure.

In a seismic survey, the seismic signal is generated by injecting an acoustic signal from on or near the earth's surface, which then travels downwardly into the subsurface of the earth. In a marine survey, the acoustic signal may also travel downwardly through a body of water. Appropriate energy sources may include explosives or vibrators on land and air guns or marine vibrators in water. When the acoustic signal encounters a seismic reflector, an interface between two subsurface strata having different acoustic impedances, a portion of the acoustic signal is reflected back to the surface, where the reflected energy is detected by a sensor and recorded.

Appropriate types of seismic sensors may include particle velocity sensors in land surveys and water pressure sensors in marine surveys. Particle acceleration sensors may be used. instead of particle velocity sensors. Particle velocity sensors are commonly know in the art as geophones and water pressure sensors are commonly know in the art as hydrophones. Both seismic sources and seismic sensors may be deployed by themselves or, more commonly, in arrays.

Seismic waves may be generated as pressure or compressional waves (also called p-waves) and as shear waves (also called s-waves). A pressure wave induces compression, or particle motion, back and forth, in the longitudinal direction of wave propagation, and thus is also called a longitudinal wave. A shear wave induces elastic deformation, or particle motion, side to side, transverse to the direction of wave propagation, and thus is also called a transverse wave. Shear waves can only form in a medium that will support them. For example, fluids such as water will not support the transmission of shear waves, while solids such as the water bottom will. Although both pressure and shear waves may be generated and detected in a marine seismic survey, often the pressure waves to be detected by the hydrophones are the only waves of interest. Shear waves, from mode conversions of pressure waves or otherwise generated, would then be unwanted noise.

In a typical marine seismic survey, a seismic vessel travels on the water surface, typically at about 5 knots, and contains seismic acquisition control equipment, such as navigation control, seismic source control, seismic sensor control, and recording equipment. The seismic acquisition control equipment causes a seismic source towed in the body of water by the seismic vessel to actuate at selected times. The seismic source may be of any type well known in the art of seismic acquisition, including airguns or water guns, or most commonly, arrays of airguns. Seismic streamers, also called seismic cables, are elongate cable-like structures towed in the body of water by the original seismic survey vessel or by another seismic survey ship. Typically, a plurality of seismic streamers are towed behind the seismic vessel. The seismic streamers contain sensors to detect the reflected wavefields initiated by the seismic source and reflected from interfaces in the environment. Conventionally, the seismic streamers contain pressure sensors such as hydrophones, but seismic streamers have been proposed that contain water particle motion sensors, such as geophones, in addition to hydrophones. The sensor are typically located at regular intervals along the seismic streamers.

Seismic streamers also comprise electronic modules, electrical wires and sensors. Seismic streamers are typically divided into sections approximately 100 meters in length, and can extend to a total length of many thousands of meters. Position control devices such as depth controllers, paravanes, and tail buoys are used to regulate and monitor the movement of the seismic streamers. A marine seismic data gathering system comprises seismic sources and seismic streamers. Seismic data gathering operations are becoming progressively more complex, as more sources and streamers are being employed. A common feature of these source and streamer systems is that they can be positioned astern of and to the side of the line of travel of the seismic vessel. In addition, the sources and streamers are submerged in the water, with the seismic sources typically at a depth of 5-15 meters below the water surface and the seismic streamers typically at a depth of 5-40 meters.

A typical streamer section consists of an external jacket, connectors, spacers, and strength members. The external jacket protects the interior of the streamer section from water ingress. The connectors at the ends of each streamer section link the section mechanically, electrically and/or optically to adjacent sections and, hence, ultimately to the seismic towing vessel. The strength members, usually two or more, run down the length of each streamer section from end connector to connector, providing axial mechanical strength. A wire bundle also runs down the length of each streamer section, containing electrical power conductors and electrical data communication wires. In some instances, fiber optics for data communication are included in the wire bundle. Hydrophones or groups of hydrophones are located within the streamer. The hydrophones have sometimes been located within the spacers for protection. The distance between spacers is normally about 0.7 meters. A hydrophone group, typically comprising 8 or 16 hydrophones, normally extends for a length of about 12.5 meters.

The interior of the seismic streamers is filled with a core material to provide buoyancy and desirable acoustic properties. For many years, most seismic streamers have been filled with a fluid core material. This fluid-filled streamer design is well proven and has been used in the industry for a long time. However, there are two main drawbacks with this type of design. The first drawback is leakage of the fluid into the surrounding water when a streamer section is damaged and cut. Since the fluids in the streamers are typically hydrocarbons, such as kerosene, this leakage is a serious environmental problem. This damage can occur while the streamer is being towed through the water or it can occur while the streamer is being deployed from or retrieved onto the streamer winch on which streamers are typically stored on the seismic tow vessel.

The second drawback to using fluid-filled streamer sections is the noise generated by vibrations as the streamer is towed through the water. These vibrations develop internal pressure waves traveling through the fluid in the streamer sections, which are often referred to as “bulge waves” or “breathing waves”. This noise is described, for example, in the paper S. P. Beerens et al., “Flow Noise Analysis of Towed Sonar Arrays”, UDT 99—Conference Proceedings Undersea Defense Technology, Jun. 29-Jul. 1, 1999, Nice, France, Nexus Media Limited, Swanley, Kent.

In the ideal situation of a streamer moving at constant speed, all the components—the outer skin, connectors, spacers, strength members, and fluid core material—are not moving relative to each other. In realistic conditions, however, vibrations of the seismic streamer leading to transient motion of the strength members are caused by such events as pitching and heaving of the seismic vessel, paravanes, and tail buoys attached to the streamers; strumming of the towing cables attached to the streamers caused by vortex shedding on the cables, or operation of depth-control devices located on the streamers. The transient motion of the strength members displaces the spacers or connectors, causing pressure fluctuations in the fluid core material that are detected by the hydrophones. The pressure fluctuations radiating away from the spacers or connectors also cause the flexible outer skin to bulge in and out as a traveling wave, giving this phenomenon its name.

In addition, there are other types of noise, often called flow noise, which can affect the hydrophone signal. For example, vibrations of the seismic streamer can cause extensional waves in the outer skin and resonance transients traveling down the strength members. A turbulent boundary layer created around the outer skin of the streamer by the act of towing the streamer can also cause pressure fluctuations in the fluid core material. In fluid filled streamer sections, the extensional waves, resonance transients, and turbulence-induced noise are typically much smaller in amplitude than the bulge waves. Bulge waves are usually the largest source of vibration noise because these waves travel in the fluid core material filling the streamer sections and thus act directly on the hydrophones.

Several ways have been attempted to reduce the noise problem in steamer sections. For example, a first approach is to introduce compartment blocks in fluid-filled streamer sections to stop the vibration-caused bulge waves from traveling continuously along the streamer. A second approach is to introduce open cell foam into the interior cavity of the streamer section. The open cell foam restricts the flow of the fluid fill material in response to the transient pressure change and causes the energy to be dissipated into the outer skin and the foam over a shorter distance. A third approach to address the noise problem is to combine several hydrophones into a group to attenuate a slow moving wave. An equal number of hydrophones are positioned between or on both sides of the spacers so that pairs of hydrophones sense equal and opposite pressure changes. Summing the hydrophone signals from a group can then cancel out some of the noise.

Another approach to eliminating the bulge waves is to eliminate the fluid from the streamer sections, so that no medium exists in which bulge waves can develop. This approach is exemplified by the use of so-called solid streamers, using streamer sections filled with a solid core material instead of a fluid. However, in any solid type of material, some shear waves will develop, which can increase the noise detected by the hydrophones. Note that shear waves cannot develop in a fluid fill material since fluids have no shear modulus. Additionally, many conventional solid core materials are not acoustically transparent to the desired pressure waves.

A further approach to solving the noise problem is to replace the fluid core material in a streamer section with a softer solid core material. The introduction of a softer solid material may block the development of bulge waves compared to a fluid core material. A softer solid material may also attenuate the transmission of shear waves in comparison to a harder material. However, there can still be a substantial transmission of shear waves through the softer solid material to the hydrophones.

Thus, a need exists for a means to mount a hydrophone in a marine seismic streamer section that allows pressure waves to be transmitted through to the hydrophone, while substantially attenuating or even preventing the transmission of bulge waves and shear waves to the hydrophone.

### BRIEF SUMMARY OF THE INVENTION

The invention is an apparatus for attenuating noise in marine seismic streamers. In one embodiment, the invention comprises a marine seismic streamer, a hydrophone housing positioned in the marine seismic streamer, the hydrophone housing having ends and substantially rigid side walls, a hydrophone positioned in the hydrophone housing, a soft compliant solid material filling the housing and the marine seismic streamer, and openings in the hydrophone housing adapted to substantially permit passage of pressure waves and to substantially attenuate passage of shear waves.

In one embodiment, the openings are open ends of the hydrophone housing. In another embodiment, the openings are in the side walls of the hydrophone housing. In yet another embodiment, the openings are in the substantially rigid closed end walls of the hydrophone housing. In a yet further embodiment, the openings are in both the end walls and in the side walls of the hydrophone housing.

In an alternative embodiment, the invention comprises a hydrophone housing with ends and substantially rigid side walls and openings in the hydrophone housing adapted to substantially permit passage of pressure waves and to substantially attenuate passage of shear waves.

### BRIEF DESCRIPTION OF THE DRAWINGS

The invention and its advantages may be more easily understood by reference to the following detailed description and the attached drawings, in which:

FIG. 1 is a perspective schematic view of a seismic streamer section adapted to hold hydrophone housings according to the invention;

FIG. 2 is a perspective view of an embodiment of the hydrophone housing of the invention with open ends;

FIGS. 3A and 3B are perspective views of embodiments of an enclosed hydrophone housing with openings in the closed end walls;

FIGS. 4A and 4B are perspective views of embodiments of an enclosed hydrophone housing with openings in the side walls; and

FIG. 5 is a perspective view of an embodiment of an enclosed hydrophone housing, with openings both in the closed end walls and in the side walls.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

The invention is apparatus for attenuating noise in marine seismic streamers. In one embodiment, the invention comprises a hydrophone housing for mounting hydrophones within a seismic streamer section. In an alternative embodiment, the invention comprises a seismic streamer with the hydrophone housing and enclosed hydrophone mounted within, along with a soft compliant solid core material filling both the streamer and housing. In a particular embodiment, the invention comprises a hydrophone assembly that attenuates both bulge waves and shear waves, while allowing pressure waves to enter, thereby increasing the signal-to-noise ratio of the signal detected by the hydrophones within.

The hydrophone assembly of the invention attenuates noise, such as bulge waves, by employing a soft compliant solid material as core material to fill the hydrophone housing as well as the seismic streamer sections. Further, the soft compliant solid material is acoustically transparent to pressure waves. The hydrophone housing attenuates shear waves by employing substantially rigid side and end walls along with openings adapted to substantially permit passage of pressure waves and to substantially attenuate passage of shear waves. In one embodiment, the openings are the open ends of the hydrophone housing. In other embodiments, the openings are located in the side walls of the hydrophone housing, located in the end walls of the hydrophone housing, or located in both the side walls and the end walls of the hydrophone housing.

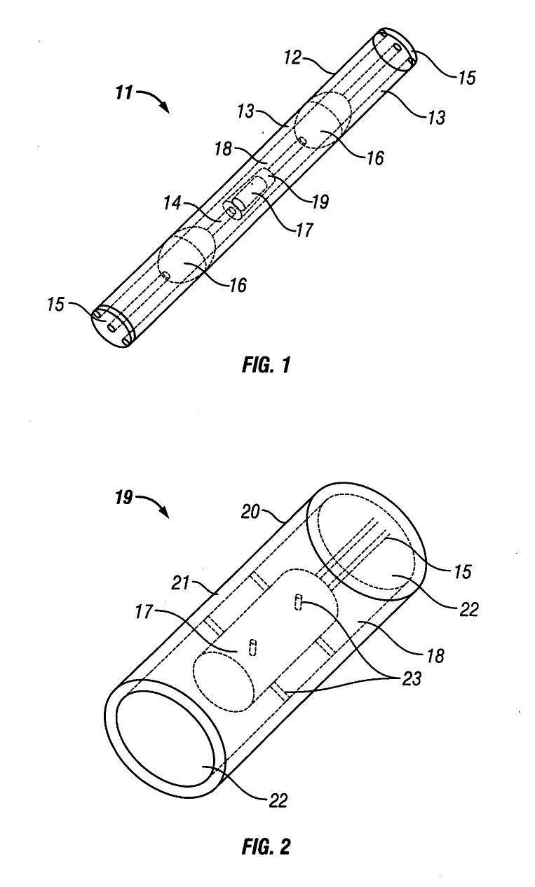

FIG. 1 shows a perspective schematic view (not to scale) of a seismic streamer section in accordance with a preferred embodiment of the invention. A marine seismic streamer is typically composed of streamer sections, one of which is illustrated and designated generally by the reference numeral 11. Each seismic streamer section 11 comprises primarily an external jacket 12, inner strength members 13, a wire bundle 14, connectors 15, and spacers 16. The external jacket 12 is in the general form of an elongated flexible cylinder, preferably manufactured as an extruded jacket. The outer skin 12 protects the interior of the streamer section 11 from the corrosive effects of water ingress. The inner strength members 13 extend along the longitudinal direction of the streamer sections 11, typically positioned adjacent the outer skin 12 and running from the connector 15 at one end of the seismic section 11 to the connector 15 at the other end. Typically, at least two inner strength members 13 are employed in each streamer section 11. The strength members 13 provide axial mechanical strength for the seismic section 11. The wire bundle 14 is typically centered coaxially in the streamer section 11 and extends along the longitudinal direction of the streamer section 11. The wire bundle 14 provides power and data transmissions from the seismic towing vessel. The wire bundle 14 contains electrical power conductors and data communication wires, and, in some instances, fiber optics for data communication. The connectors 15 are located at both ends of the streamer section 11. The connectors 15 link the seismic sections 11 mechanically, electrically and/or optically to adjacent sections 11 and allow the electrical wire bundles to provide power and data transmission to and from each of the seismic sections 11.

The spacers 16 are located at intervals along the interior of the streamer section 11. The spacers support the external jacket 12, inner strength members 13, and wire bundle 14. In conventional seismic streamers sections 11, hydrophones are often enclosed in the spacers 16 for mounting and protection. In the invention, however, the hydrophones 17 are mounted in hydrophone housings 19 instead of in the spacers 16. In one embodiment, the hydrophone housings 19 are radially centered about the longitudinal axis of the seismic streamer section 11. However, this position is not intended as a limitation of the invention. In a preferred embodiment, each hydrophone 17 is connected to the wire bundle 14 via electrical conductors (shown in later figures). The interior of the streamer section 11 is filled with a core material comprising a soft compliant solid material 18.

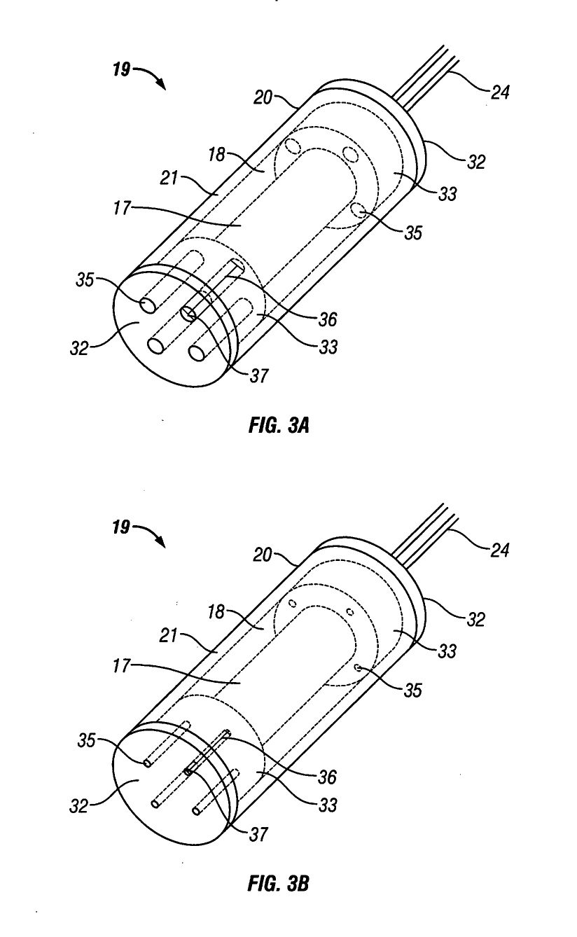

The hydrophone housings of the invention can be made in different embodiments. FIG. 2 shows a perspective view of one embodiment of a hydrophone housing 19 according to the invention. The hydrophone housing 19 comprises primarily a substantially rigid cylinder 20 with side walls 21 and open ends 22. The hydrophone housing 19 is shown here in FIG. 2 and in further FIGS. 3A, 3B, 4A, 4B, and 5 as having a cylindrical shape for illustrative purposes only. The invention is not intended to be restricted to a cylindrically-shaped hydrophone housing 19, but encompasses any functionally equivalent hydrophone housing 19.

A hydrophone 17 is enclosed within the hydrophone housing 19. The hydrophone 17 is held in place by structural supports 23 attached between the hydrophone 17 and the side walls 21 of the rigid cylinder 20 of the hydrophone housing 19. The number and arrangement of the structural supports 23 are adapted to allow the passage of pressure waves in the interior of the hydrophone housing 19 for detection by the hydrophone 17. The hydrophone 17 is connected to the wire bundle 14 (of FIG. 1) of the streamer section 11 by electrical conductors 24 which pass through one of the open ends 22 of the hydrophone housing 19. The interior of the hydrophone housing 19 is also filled with the soft compliant solid material 18 that fills the seismic streamer section 11 as core material.

The soft compliant solid material 18 is employed in the invention instead of conventional fluid or solid core materials in the hydrophone housing 19 as well as in the streamer section 11. Employing the soft compliant solid core material 18 instead of fluid core material prevents the formation of bulge waves, which would add noise to the signal detected by the hydrophone 17. Employing the soft compliant solid material 18 instead of solid core material allows pressure waves to pass through to the hydrophone 17 for detection, since the soft compliant solid material 18 is adapted to be acoustically transparent. Additionally, the soft compliant solid material 18 is less supportive of shear waves than conventional solid core material, although shear waves are not completely attenuated by the soft compliant solid material 18.

To complement the use of the soft compliant solid material 18, the hydrophone housing 19 employed in the invention is designed to allow the passage of pressure waves to the hydrophone 17, while attenuating the passage of shear waves. The hydrophone housing 19 allows access to its interior through openings adapted to restrict movement in the soft compliant solid material 18 which would be transverse to the direction of travel of the incoming pressure wave. Since the particle motion in shear waves is transverse to the longitudinal travel direction of pressure waves, shear waves are thereby attenuated.

Thus, the hydrophone housing 19 is designed to allow the entry of the desired pressure waves, but not the entry of the undesired shear waves. In the embodiment illustrated in FIG. 2, the rigid side walls 21 of the hydrophone housing 19 will stop any waves that are not propagating along the longitudinal direction of the hydrophone housing 19. Thus, waves can only enter the hydrophone housing 19, to be detected by the protected hydrophone 17, along the longitudinal direction of the cylindrical hydrophone housing 19 and through one of the open ends 22 of the hydrophone housing 19. This wave entry direction corresponds to the inline direction of the streamer section 11.

In the embodiment illustrated in FIG. 2, the cylindrical hydrophone housing 19 is about twice as long as the hydrophone 17. This relationship between lengths has been heuristically determined to be effective in attenuating shear wave propagation into the hydrophone housing and to the hydrophone. Additionally, the hydrophone housing 19 has been found effective in attenuating flow noise. Local effects such as pressure fluctuations from the external jacket 12 of the streamer section 11 will be detected by the hydrophone 17 only after entering from the open ends 22 of the longer hydrophone housing 19. Thus, the flow noise will originate from a larger area of the outer skin. Averaging the flow noise from the larger area will cancel out some of it.

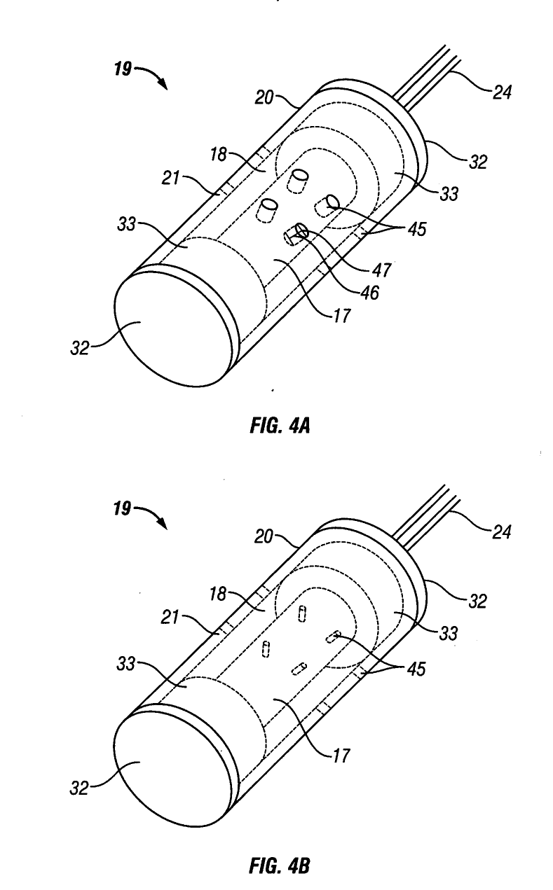

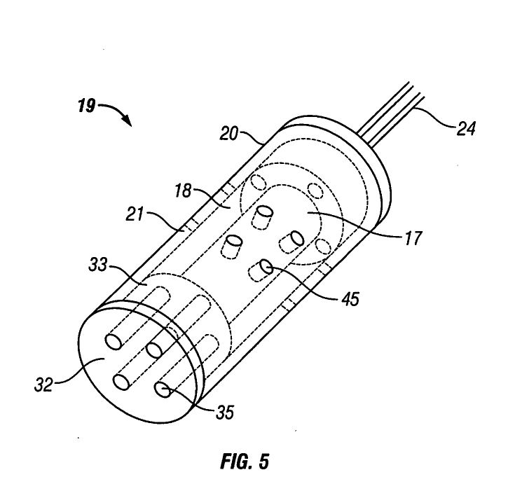

FIGS. 3A, 3B, 4A, 4B and 5 show perspective views of various embodiments of the hydrophone housing 19 of the invention with various combinations of openings in the side walls and end walls of an enclosed hydrophone housing 19. FIGS. 3A and 3B show embodiments with openings in the end walls, while FIGS. 4A and 4B show embodiments with openings in the side walls. Finally, FIG. 5 shows a further embodiment with openings in both the side walls and end walls. The hydrophone housings 19 illustrated in each of FIGS. 3A, 3B, 4A, 4B and 5 comprise primarily a substantially rigid cylinder 20 with side walls 21 and closed end walls 32 (instead of the open ends 22 of the embodiment illustrated in FIG. 2). Note that the invention is not intended to be restricted to a cylindrically-shaped hydrophone housing 19, but encompasses any appropriately-shaped hydrophone housing 19. A hydrophone 17 is again enclosed in the hydrophone housing 19. The hydrophone 17 is held in place by end holders 33 attached to both closed end walls 32 of the cylinder 20. The holders 33 may also be attached to the side walls 21 of the cylinder 20 by additional structural supports (not shown). The hydrophone 17 is connected by electrical conductors 24 which pass through one of the holders 33 in one of the closed end walls 32 and connect to the electrical conductors 15 of the streamer section 11. The interior of the hydrophone housing 19 is filled with the soft compliant solid material 18 used to fill the seismic streamer section 11 as core material.

FIGS. 3A and 3B show embodiments of an enclosed hydrophone housing 19 with openings 35 in the closed end walls 32. The hydrophone housing 19 is designed to attenuate shear waves. The substantially rigid side walls 21 of the hydrophone housing 19 will substantially stop any waves that are not propagating along the longitudinal direction of the hydrophone housing 19. The openings 35 positioned in each of the closed end walls 32 of the cylinder 20 are adapted to allow pressure waves to enter the interior of the hydrophone housing 19 to be detected by the hydrophone 17. Additionally, the openings 35 are dimensioned to act as shear wave attenuation ports. The ratio between the length 36 and the diameter 37 of the openings 35 is heuristically determined, and will depend on the viscosity (and hence, shear modulus) of the soft compliant solid material 18, so that transverse motion of the soft compliant solid material 18 is restricted in the openings 35. Then, longitudinal pressure waves will substantially pass through the openings 35 into the interior of the hydrophone housing 19, where the hydrophone 17 is located. Shear waves, however, with particle motion transverse to the longitudinal axes of the openings 35, will be substantially prevented from passing through the openings 35 into the interior of the hydrophone housing 19.

FIG. 3A shows an embodiment in which both the length 36 and the diameter 37 of the openings 35 is relatively large. FIG. 3b shows an embodiment in which both the length 36 and the diameter 37 of the openings 35 is relatively small. In both cases, pressure waves will be allowed to enter the hydrophone housing 19 though the openings 35, while shear waves will be attenuated. The number and arrangement of the openings 35 in the hydrophone housing 19, as illustrated in FIGS. 3A and 3B, is for illustrative purposes only and is not intended as a limitation of the invention. The number and arrangement of openings 35 need only be enough to ensure the passage of sufficient pressure wave energy into the interior of the hydrophone housing 19 to be detected by the hydrophone 17.

FIGS. 4A and 4B show further embodiments of an enclosed hydrophone housing 19 with openings 45 in the side walls 21. The hydrophone housing 19 is designed to attenuate shear waves. The substantially rigid closed end walls 32 of the hydrophone housing 19 will substantially stop any waves that are not propagating transversely to the longitudinal direction of the hydrophone housing 19. The openings 45 positioned in the side walls 21 of the cylinder 20 are adapted to allow pressure waves to enter the interior of the hydrophone housing 19 to be detected by the hydrophone 17. Additionally, the openings 45 are dimensioned to act as shear wave attenuation ports. The ratio between the length 46 and the diameter 47 of the openings 35 is heuristically determined, and will depend on the viscosity of the soft compliant solid material 18, so that transverse motion of the soft compliant solid material 18 is restricted in the openings 45. Then, transverse pressure waves will substantially pass through the openings 45 into the interior of the hydrophone housing 19, where the hydrophone 17 is located. Shear waves, however, with particle motion transverse to the longitudinal axes of the openings 45, will be substantially prevented from passing through the openings 45 into the interior of the hydrophone housing 19.

FIG. 4A shows an embodiment in which both the length 46 and the diameter 47 of the openings 45 is relatively large, while FIG. 4b shows an embodiment in which both the length 46 and the diameter 47 of the openings 45 is relatively small. In both cases, pressure waves will be allowed to enter the hydrophone housing 19 though the openings 45, while shear waves will be attenuated. The number and arrangement of the openings 45 in the hydrophone housing 19, as illustrated in FIGS. 4A and 4B, is for illustrative purposes only and is not intended as a limitation of the invention. The number and arrangement of openings 45 need only be enough to ensure the passage of sufficient pressure wave energy into the interior of the hydrophone housing 19 to be detected by the hydrophone 17.

FIG. 5 shows a perspective view of a further embodiment of an enclosed hydrophone housing 19, with openings both in the closed end walls 32 and in the side walls 21. Openings 35 are positioned in the closed end walls 32 of the cylinder 20, as in FIGS. 3A and 3B, and openings 45 are also positioned in the side walls 21 of the cylinder 20, as in FIGS. 4A and 4B. Both openings 35 in the closed end walls 32 and openings 45 in the side walls 21 are dimensioned as discussed above to allow pressure waves to enter the hydrophone housing 19 to be detected by the hydrophone 17, while attenuating the entry of shear waves. The number and arrangement of the openings 35, 45 in the hydrophone housing 19, as illustrated in FIG. 5, is for illustrative purposes only and is not intended as a limitation of the invention.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

1. A marine seismic streamer section, comprising:
an external jacket;
a hydrophone housing positioned in said external jacket, the hydrophone housing having ends and substantially rigid side walls;
a hydrophone positioned in the hydrophone housing;
a soft compliant solid material filling said external jacket and said hydrophone housing; and
openings in the hydrophone housing dimensioned to restrict movement of the soft compliant solid material transverse to longitudinal axes of the openings, to substantially permit passage of pressure waves into the housing and to substantially reduce passage of shear waves into the housing.

2. The marine seismic streamer section of claim 1, wherein the openings in the hydrophone housing are open ends of the hydrophone housing.

3. The marine seismic streamer section of claim 2, wherein the hydrophone housing is approximately twice as long as the hydrophone.

4. The marine seismic streamer section of claim 1, wherein the openings are in the side walls of the hydrophone housing.

5. The marine seismic streamer section of claim 1, wherein
the ends of the hydrophone housing comprise substantially rigid end walls; and
the openings are in the end walls of the hydrophone housing.

6. The marine seismic streamer section of claim 5, wherein the openings are in the end walls and in the side walls of the hydrophone housing.

7. The marine seismic streamer section of claim 1, wherein the hydrophone housing is radially centered about the longitudinal axis of the marine seismic streamer.

8. An apparatus for attenuating noise in marine seismic streamers, comprising:
a hydrophone housing with ends and substantially rigid side walls;
a soft compliant solid material filling said hydrophone housing; and
openings in the hydrophone housing dimensioned to restrict movement of the soft compliant solid material transverse to longitudinal axes of the openings, to substantially permit passage of pressure waves into the housing and to substantially attenuate passage of shear waves into the housing.

9. The apparatus of claim 8, further comprising a hydrophone positioned in the hydrophone housing.

10. The apparatus of claim 9, wherein the hydrophone housing is positioned in a marine seismic streamer.

11. The apparatus of claim 10, further comprising a soft compliant solid material filling the marine seismic streamer.

12. The apparatus of claim 9, wherein the openings are open ends of the hydrophone housing.

13. The apparatus of claim 12, wherein the hydrophone housing is approximately twice as long as the hydrophone.

14. The apparatus of claim 8, wherein the openings are in the side walls of the hydrophone housing.

15. The apparatus of claim 8, wherein
the ends of the hydrophone housing comprise substantially rigid end walls; and
the openings are in the end walls of the hydrophone housing.

16. The apparatus of claim 15, wherein the openings are in the end walls and in the side walls of the hydrophone housing.

17. The apparatus of claim 8, wherein the hydrophone housing is radially centered about the longitudinal axis of the marine seismic streamer.
